(19) United States
(12) Patent Application Publication
(10) Pub. No.: US 2026/0194232 A1
(43) Pub. Date: Jul. 9, 2026

(54) HEATING CONTROL METHOD FOR OVEN, AND OVEN

(71) Applicant: Heshan Hengkai Electrical Manufacture Co., Ltd., Heshan, Jiangmen (CN)

(72) Inventor: Beihe LI, Heshan, Jiangmen (CN)

(73) Assignee: Heshan Hengkai Electrical Manufacture Co., Ltd., Heshan, Jiangmen (CN)

(21) Appl. No.: 18/865,552

(22) PCT Filed: Jun. 17, 2022
(86) PCT No.: PCT/CN2022/099537

§ 371 Date: Nov. 13, 2024

(30) Foreign Application Priority Data
May 17, 2022 (CN) 202210536519.6

(51) Int. Cl. F24C 7/08; A47J 37/01; A47J 37/06

(52) U.S. Cl. CPC F24C 7/087; A47J 37/015; A47J 37/0641

(57) ABSTRACT

A heating control method for an oven (1000), and an oven (1000). The control method comprises: obtaining a preheating instruction (S501); controlling, according to the preheating instruction, a heating apparatus (200) to heat a baking cavity (110) at a first power (S502); obtaining the temperature of the baking cavity (110) (S503); when the temperature of the baking cavity (110) is greater than or equal to a preheating temperature, performing heat preservation operation at the preheating temperature (S504); obtaining a baking instruction (S505); controlling, according to the baking instruction, the heating apparatus (200) to enter a quick heating mode, comprising controlling the heating apparatus (200) to heat the baking cavity (110) at a second power (S506); when the temperature of the baking cavity (110) is greater than or equal to a baking temperature, controlling the heating apparatus (200) to perform heat preservation operation at the baking temperature, the baking temperature being greater than or equal to the preheating temperature (S507); after the heating apparatus (200) is in the quick heating mode for a first preset duration, controlling the heating apparatus (200) to stop heating (S508), or perform heat preservation operation at a preset temperature, the preset temperature being less than or equal to the preheating temperature (S510). When a user puts food into the baking cavity (110) and starts a corresponding button, the heating apparatus (200) continues heating, so that the oven (1000) can be heated to a higher temperature, thereby accelerating baking of the food, and shortening the required time.

### TECHNICAL FIELD

The present disclosure relates to the field of ovens, and in particular, to a heating control method for an oven, and an oven.

### BACKGROUND

The maximum temperature of ovens in the existing technology can merely be set at 230° C., so that it takes a long time, usually more than 20 minutes, to make pizza, steaks and other foods, which cannot meet the user's need for quick baking of food.

### SUMMARY

The present disclosure aims to solve at least one of the technical problems existing in the existing technology. To this end, the present disclosure provides a heating control method for an oven, and accordingly, the food preparation time can be shortened.

The present disclosure also provides an oven with the above heating control method.

A heating control method for an oven is provided according to an embodiment in a first aspect of the present disclosure.

The oven includes a body and a heating device, a baking cavity is defined in the body, a size of the baking cavity in a vertical direction is less than that of any side of the baking cavity in a horizontal direction, and the heating device is disposed in the baking cavity and is arranged in the horizontal direction.

The control method for the oven includes:
acquiring a preheating instruction;
controlling, according to the preheating instruction, the heating device to heat the baking cavity at a first power;
acquiring a temperature in the baking cavity;
in response to the temperature in the baking cavity being greater than or equal to a preheating temperature, controlling the heating device to perform a heat preservation operation at the preheating temperature;
acquiring a baking instruction;

controlling, according to the baking instruction, the heating device to enter a quick heating mode, where controlling the heating device to enter the quick heating mode includes controlling the heating device to heat the baking cavity at a second power;

in response to the temperature in the baking cavity being greater than or equal to a baking temperature, controlling the heating device to perform the heat preservation operation at the baking temperature, where the baking temperature is greater than or equal to the preheating temperature; and
after the heating device is in the quick heating mode for a first preset duration, controlling the heating device to stop heating or to perform the heat preservation operation at a preset temperature, where the preset temperature is less than the preheating temperature.

The heating control method for an oven according to an embodiment of the present disclosure at least has the following beneficial effects:

The baking cavity is in a flat shape to bring the heating device closer to food, which can improve the cooking efficiency of the food. Before food making, the oven is preheated at a medium-high temperature. After the preheating is completed, the user puts in the food and activates the quick heating mode, and the oven heats at the second power. The food heated at a high temperature can greatly shorten the cooking time of the food. Moreover, the surface of the food is instantly browned under the high temperature, and the moisture inside the food can be retained to enhance the taste of the food.

According to some embodiments of the present disclosure, the oven further includes a baking pan installed in the baking cavity, and the heating device includes an upper heating tube and a lower heating tube that are respectively located above and below the baking pan;
where, controlling, according to the baking instruction, the heating device to enter the quick heating mode includes:
in response to the baking instruction being a first mode instruction, controlling the upper heating tube to heat at a third power, and controlling the lower heating tube to heat at a fourth power.

According to some embodiments of the present disclosure, the baking temperature ranges from 350° C. to 370° C.

According to some embodiments of the present disclosure, the first preset duration is in a range of 3 minutes to 8 minutes.

According to some embodiments of the present disclosure, the oven further includes a baking pan installed in the baking cavity, and the heating device includes an upper heating tube located above the baking pan;
where controlling, according to the baking instruction, the heating device to enter the quick heating mode includes:
in response to the baking instruction being a second mode instruction, controlling the upper heating tube to heat at the second power.

According to some embodiments of the present disclosure, the baking temperature ranges from 400° C. to 410° C.

According to some embodiments of the present disclosure, the first preset duration is in a range of 2 minutes to 6 minutes.

According to some embodiments of the present disclosure, after controlling the heating device to perform the heat preservation operation at the preheating temperature, the heating control method further includes:
in response to the heating device performing the heat preservation operation at the preheating temperature for a second preset duration, controlling the heating device to stop heating.

According to some embodiments of the present disclosure, the second preset duration is in a range of 5 minutes to 20 minutes.

According to some embodiments of the present disclosure, the second power is greater than the first power.

According to some embodiments of the present disclosure, the preheating temperature ranges from 200° C. to 400° C.

According to some embodiments of the present disclosure, the baking temperature ranges from 300° C. to 450° C.

According to some embodiments of the present disclosure, the first preset duration is in a range of 0.5 minutes to 8 minutes.

According to some embodiments of the present disclosure, the oven further includes a fan installed on an inner sidewall of the body;
where controlling the heating device to enter the quick heating mode further includes:
controlling the fan to work, so as to speed up air circulation in the baking cavity.

An oven is provided according to an embodiment in a second aspect of the present disclosure, which includes: a processor;
a memory storing a computer program thereon which, when executed by the processor, causes the processor to implement any one of the heating control methods for an oven described in the first aspect.

The oven according to the embodiments of the present disclosure at least has the following beneficial effects:
The baking cavity is in a flat shape to bring the heating device closer to food, which can improve the cooking efficiency of the food. Before food making, the oven is preheated at a medium-high temperature. After the preheating is completed, the user puts in the food and activates the quick heating mode, and the oven heats at the second power. The food heated at a high temperature can greatly shorten the cooking time of the food. Moreover, the surface of the food is instantly browned under the high temperature, and the moisture inside the food can be retained to enhance the taste of the food.

Additional aspects and advantages of the present disclosure will be set forth in part in the description which follows, and in part will be apparent from the description, or may be understood by practice of the present disclosure.

### BRIEF DESCRIPTION OF DRAWINGS

The present disclosure will be further described below in conjunction with the accompanying drawings and embodiments, in which:

FIG. 1 is a schematic diagram of an overall structure of an oven provided by an embodiment of the present disclosure;

FIG. 2 is a schematic structural diagram of a hidden portion of the oven provided by an embodiment of the present disclosure;

FIG. 3 is a schematic diagram of the oven with a baking pan being pulled out according to an embodiment of the present disclosure;

FIG. 4 is a cross-sectional view of the oven provided by an embodiment of the present disclosure;

FIG. 5 is a flowchart of a heating control method for an oven provided by an embodiment of the present disclosure;

FIG. 6 is a flowchart of the heating control method for an oven provided by another embodiment of the present disclosure;

FIG. 7 is a flowchart of the heating control method for an oven provided by yet another embodiment of the present disclosure;

FIG. 8 is a flowchart of the heating control method for an oven to execute a first mode instruction provided by an embodiment of the present disclosure;

FIG. 9 is a flowchart of the heating control method for an oven to execute a second mode instruction according to an embodiment of the present disclosure; and

FIG. 10 is a flowchart of a heat preservation control method for an oven provided by an embodiment of the present disclosure.

### REFERENCE NUMERALS

oven 1000;
body 100; baking cavity 110; door 120;
heating device 200; upper heating tube 210; lower heating tube 220;
baking pan300;
fan 400.

### DETAILED DESCRIPTION

Embodiments of the present disclosure will be described in detail below, and examples of the embodiments are shown in the accompanying drawings, where throughout the same or similar reference numerals denote the same or similar elements or elements having the same or similar functions. The following embodiments described with reference to the accompanying drawings are exemplary and serve merely to explain the present disclosure, and should not be construed as limiting the present disclosure.

In the description of the present disclosure, it is to be understood that, referring to orientation description, the instructed orientation or positional relationships, for example, upper, lower, front, rear, left, right, etc., are based on the orientation or positional relationships shown in the accompanying drawings, merely for ease of description of the present disclosure and simplification for the description, rather than indicating or implying that the device or element referred to must have a specific orientation and be constructed and operated in a specific orientation, which, therefore, cannot be construed as limiting the present disclosure.

In the description of the present disclosure, several refers to one or more, multiple refers to two or more, greater than, less than, over and the like are understood not to include the number referred to, and above, below, within and the like are understood to include the number referred to. If described, first and second are merely for the purpose of distinguishing technical features, and not to be construed as indicating or implying relative importance or implicitly indicating the number of technical features indicated or implicitly indicating the precedence relationship of technical features indicated.

In the description of the present disclosure, unless explicitly defined otherwise, providing, installing, connecting, and other words should be understood broadly, and a person skilled in the art can reasonably determine the specific meaning of the above words in the present disclosure combined with the specific content of the technical scheme.

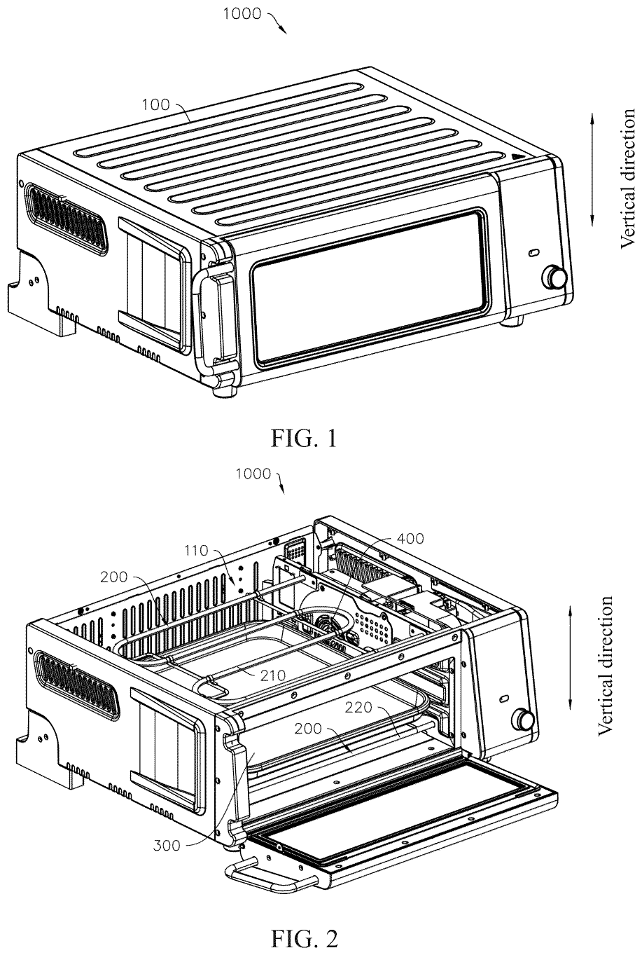

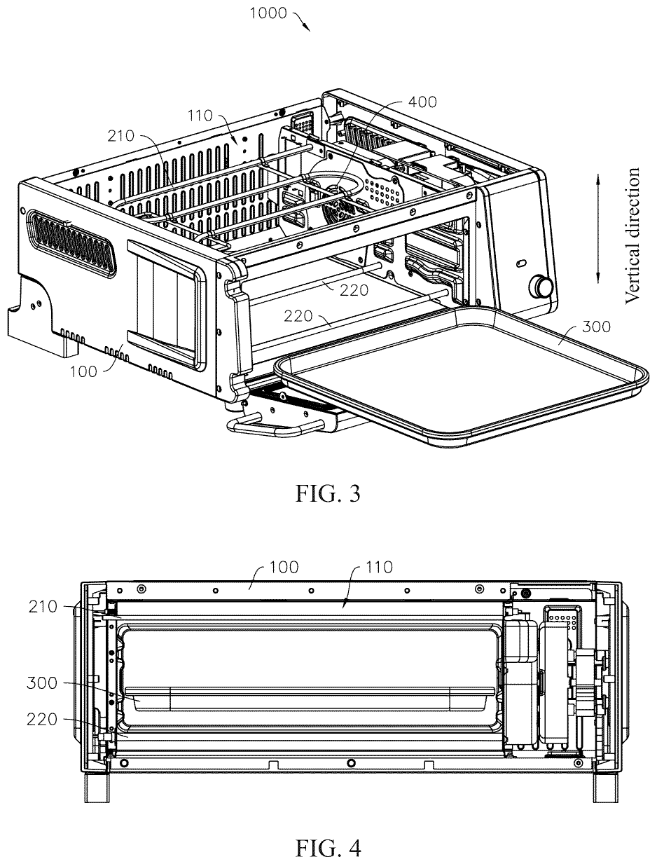

Referring to FIGS. 1, 2, and 3, an oven 1000 according to an embodiment of the present disclosure can be used to bake food. In order to shorten the food preparation time, the oven 1000 adopts a step-by-step heating control method to speed up the baking of food.

Continuing to refer to FIGS. 1, 2, and 3, in an embodiment of the present disclosure, the oven 1000 includes a body 100, a door 120, a heating device 200, a baking pan 300, and a fan 400. A baking cavity 110 is defined in the body 100 and is configured to accommodate food. The baking pan 300 is installed in the baking cavity 110 and is configured to hold food. The door 120 is rotatably connected to the body 100 to open or close the baking cavity 110. The heating device 200 is disposed in the baking cavity 110 and is configured to heat the baking cavity 110. The size of the baking cavity 110 in the vertical direction is less than that of any side of the baking cavity 110 in the horizontal direction, that is, the baking cavity 110 is in a flat shape. Moreover, the heating device 200 is arranged in the horizontal direction, so that the food can be closer to the heating device 200 during the baking process, thereby speeding up the baking of the food. The fan 400 is installed on the inner sidewall of the body 100 and is configured to speed up hot air circulation in the baking cavity 110, so as to make the temperature distribution in the oven 1000 more uniform.

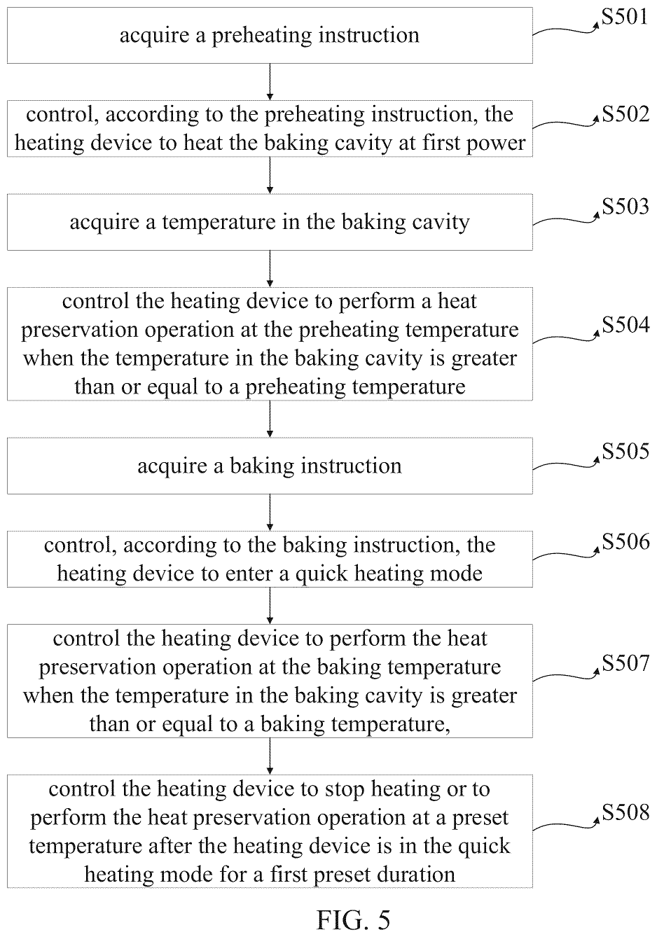

Referring to FIG. 5, the heating control method for the oven 1000 based on the above embodiments is illustrated. The method includes the following steps.

At Step S501: a preheating instruction is acquired. In an implementation, the oven 1000 is provided with a control panel. In such a case, the preheating instruction can be generated as soon as the user selects and presses the corresponding preheating button on the control panel. In another implementation, the user can control the oven 1000 online through a mobile APP, and the preheating instruction can be generated as soon as the user selects and activates the preheating function. Alternatively, the oven 1000 is set with a timed start preheating function, which allows to generate the preheating instruction when the set time is reached. An appropriate scheme is specifically selected based on the actual situation, and is no longer specifically limited here in the present disclosure.

At Step S502, the heating device 200 is controlled to heat the baking cavity 110 at first power according to the preheating instruction. It may be understood that the purpose of preheating is to improve the efficiency of heating food and effectively prevent the food from becoming dry and brittle due to excessive moisture loss during the long heating process. After the baking cavity 110 is preheated, the food is put in. The surface of the food is instantly browned under a high temperature, and the moisture inside the food can be retained to enhance the taste of the food.

During the preheating process, the first power is used for heating. In this embodiment, the setting of the first power is adapted to the preheating temperature of the oven 1000. In an embodiment of the present disclosure, the preheating temperature is 200° C. to 400° C., such as 250° C., which is higher than the maximum temperature of 230° C. of the oven 1000 in the related art, thereby providing favorable conditions for the next step of quick baking. It is to be noted that the first power is the total power of the heating device 200, and the heating device 200 includes an upper heating tube 210 and a lower heating tube 220, that is, the first power is the sum of the power of the upper heating tube 210 and the lower heating tube 220. It may be understood that the upper heating tube 210 and the lower heating tubes 220 can be preheated with the same power to ensure that the temperature in the preheated baking cavity 110 is more uniform. It is to be noted that the fan 400 can work during the preheating stage to further improve the efficiency of preheating. In addition, the oven 1000 in the related art usually has no independent preheating knob, and the user generally selects the corresponding temperature for preheating by rotating the heating knob. However, the oven 1000 in the embodiments of the present disclosure is provided with an independent preheating button. The preheating temperature can be preset by a program, and the user merely needs to press the preheating button to preheat the baking cavity 110 to the set temperature. In another embodiment of the present disclosure, the preheating temperature can also be customized by the user. After a corresponding temperature is selected, the baking cavity 110 is heated to the user-customized temperature.

At Step S503: the temperature in the baking cavity 110 is acquired. The temperature in the baking cavity 110 can be measured through a temperature sensor. The temperature sensor measures the temperature at the center of the baking cavity 110 and feeds the measured parameters back to the processor. Alternatively, a plurality of temperature sensors may be used to measure temperatures at a plurality of different locations in the baking cavity 110, the measured temperatures at the plurality of locations may be fed back to the processor, and an average value may be obtained for calculation. An appropriate scheme is specifically selected based on the actual situation, and is no longer specifically limited here in the present disclosure.

At Step S504: when the temperature in the baking cavity 110 is greater than or equal to a preheating temperature, the heating device 200 is controlled to perform a heat preservation operation at the preheating temperature. It may be understood that after preheating is completed, the user may not be able to put the food into the baking cavity 110 immediately, so that the heating device 200 needs to perform the heat preservation operation. A control logic of the heat preservation operation may be as follows: when the temperature in the baking cavity 110 is greater than or equal to the preheating temperature, the heating device 200 stops working; after a certain period of time, the temperature sensor detects that the temperature at the center of the baking cavity 110 is lower than the preheating temperature, and the heating device 200 is controlled to reheat; the power during heating may be operated at the first power or lower than the first power. Alternatively, the control logic of heat preservation operation may also be as follows: when the temperature in the baking cavity 110 is greater than or equal to the preheating temperature, the heating device 200 operates at a lower power so that the amount of the heat dissipation of the oven 1000 is approximately equal to the heating amount, thereby achieving a heat preservation effect.

It is to be noted that when the temperature in the baking cavity 110 is greater than or equal to the preheating temperature, baking prompts such as beeps and light flashes may also be issued. The oven 1000 can be equipped with a buzzer. When the preheating is completed, that is, the temperature in the baking cavity 110 is greater than or equal to the preheating temperature, the buzzer is controlled to beep to remind the user. The oven 1000 can also be equipped with a signal light. When preheating is completed, the signal light is lighted up or other methods using signal lights to prompt are adopted, which is no longer specifically limited here. Alternatively, both the buzzer and the signal light are installed. In another embodiment of the present disclosure, the preheating completion information may also be sent to the user's mobile APP to prompt the user that the preheating is completed and food can be put in for baking.

At Step S505: a baking instruction is acquired. In such a case where the oven 1000 is provided with a control panel, the baking instruction can be generated after the user selects and presses the corresponding baking button on the control panel. Alternatively, the baking instruction can be generated after selecting and pressing the baking function, when the user controls the oven 1000 online through a mobile APP. An appropriate solution is specifically selected based on the actual situation, and is no longer specifically limited here in the present disclosure.

At Step S506: the heating device 200 is controlled to enter a quick heating mode according to the baking instruction, where controlling the heating device 200 to enter a quick heating mode includes controlling the heating device 200 to heat the baking cavity 110 at a second power. For example, in the quick heating mode, the heating device 200 heats continuously the baking cavity 110 at the second power, heating the baking cavity 110 to a higher temperature that can speed up the baking of the food. In another embodiment of the present disclosure, the heating device 200 intermittently heats the baking cavity 110 at the second power. In an example, every time heating for 1 minute, the heating device 200 stops heating for 10 seconds, and then heats for another 1 minute. The period is cycled for intermittent heating. Alternatively, intermittent heating can also be carried out in a non-periodic mode. In an example, the heating device 200 first heats for 5 minutes, then stops heating for 10 seconds, and then heats again for 2 minutes. An appropriate heating logic can be specifically selected based on the actual situation, and is no longer specifically limited here in the present disclosure.

It may be understood that after controlling the heating device 200 to enter a quick heating mode in step S206, the heating control method may also include: controlling the fan 400 to work, so as to speed up air circulation in the baking cavity 110. The fan 400 is configured to speed up hot air circulation in the baking cavity 110 to make the temperature distribution in the oven 1000 more uniform. It is to be noted that whether the fan 400 is turned on depending on the food being baked. When the food needs to be tasted dry, such as grilling steaks and biscuits, the fan 400 is turned on; when the food needs to retain moisture, such as baking pizza or cake, the fan 400 is turned off.

At Step S507: when the temperature in the baking cavity 110 is greater than or equal to a baking temperature, the heating device 200 is controlled to perform a heat preservation operation at the baking temperature, where the baking temperature is greater than the preheating temperature. It may be understood that the temperature being too high can easily cause carbonization of the food surface and loss of moisture. After the temperature in the baking cavity 110 rises to the baking temperature, the heating device 200 needs to perform the heat preservation operation at the baking temperature. In an embodiment of the present disclosure, the baking temperature ranges from 300° C. to 450° C. It is to be noted that the baking temperature needs to meet the condition of being greater than the preheating temperature. For example, if the preheating temperature is 250° C., the baking temperature can be 300° C.; if the preheating temperature is 400° C., the baking temperature can be 410° C.

It is to be noted that the baking instruction also includes parameter information of a preset baking temperature value, for example, the baking temperature ranges from 350° C. to 410° C. It is to be noted that the baking temperature can be preset by a program, and the user merely needs to press the baking button to heat the baking cavity 110 to the set temperature. For example, the baking temperature is set in a lower range for vegetables, pastries, small amounts of meat, etc.; the baking temperature is set in a higher range for some large pieces of meat, such as steak, lamb chops, and roast chicken. The baking temperature can also be customized by the user. After a corresponding temperature is selected, the baking cavity 110 is heated to the user-customized temperature.

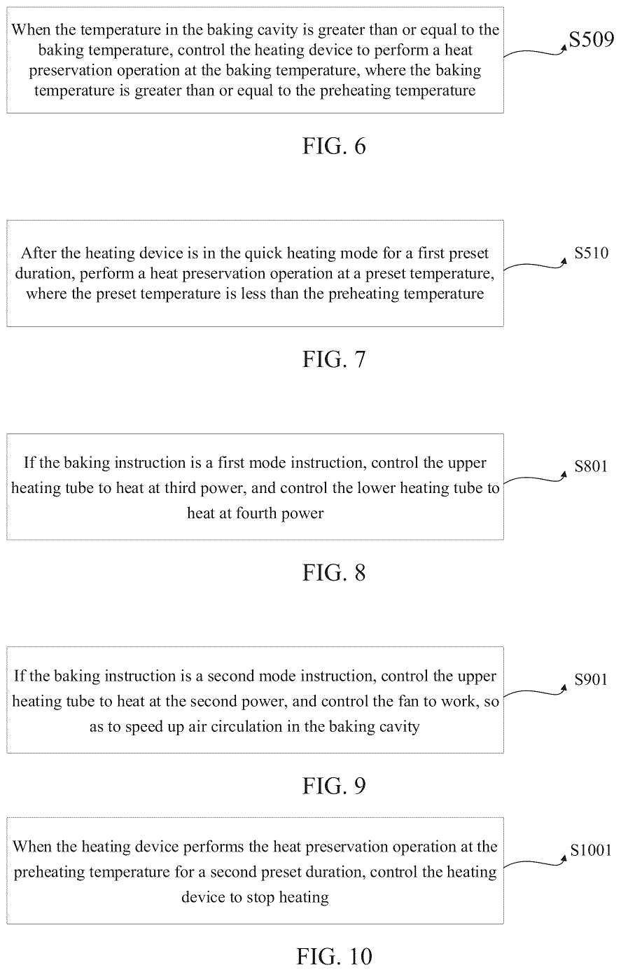

It may be understood that, referring to FIG. 6, step S509 may also be included after step S506: when the temperature in the baking cavity 110 is greater than or equal to the baking temperature, the heating device 200 is controlled to perform a heat preservation operation at the baking temperature, where the baking temperature is equal to the preheating temperature. For example, the temperature of the oven 1000 is directly raised to 350-410° C. during the preheating stage, and after the food is put into the baking cavity 110, baking is continued at this temperature. Therefore, the time required for the stage from preheating temperature to baking temperature is reduced, which can further shorten the food preparation time.

At Step S508: after the heating device 200 is in the quick heating mode for a first preset duration, the heating device 200 is controlled to stop heating. In an embodiment of the present disclosure, the first preset duration ranges from 0.5 minutes to 8 minutes, while the first preset duration, or baking time, of ovens on the market is usually more than 20 minutes. It may be understood that the baking temperature of the oven 1000 in the embodiments of the present disclosure is usually higher than that of the oven 1000 on the market. Although the high temperature can make the surface of the food crispy and the interior of the food still maintains a certain amount of moisture, the baking time should not be too long, so as to prevent the surface of the food from being burnt and causing a poor taste after drying. Therefore, after entering the quick heating mode and reaching the first preset duration, the heating needs to be stopped to prevent the food from being scorched and to prevent the temperature of the outer surface of the body 100 from being too high, thereby improving the safety of the oven 1000.

It may be understood that, referring to FIG. 7, step S510 may also be included after step S507: after the heating device 200 is in the quick heating mode for a first preset duration, a heat preservation operation is performed at a preset temperature, where the preset temperature is less than the preheating temperature. For example, the preheating temperature is 250° C., and the preset temperature is 65° C. When the food is not taken out immediately, the preset temperature of 65° C. can serve as a heat preservation function to prevent the food from becoming cold and affecting the taste after being left for a long time.

It may be understood that the heating control method for the oven 1000 mainly includes two stages: a preheating stage and a continued heating stage. The main function of the preheating stage lies in that the food after preheating is put in, so that the food can be instantly grilled at a high temperature, the surface is browned, and the moisture inside the food is retained, thereby improving the taste. The main function of the continued heating stage lies in that the baking of food is speeded up, making the surface of the food crispy, and shortening the user's waiting time.

In an embodiment of the present disclosure, the second power is greater than the first power. For example, when the machine power of the oven 1000 is 2000W, the first power of the heating device 200 may be 1600W during preheating, and the second power of the heating device 200 may be 1800W during baking. Since the temperature of the heating device 200 itself is already high enough in the preheating stage, when heating is performed with a higher power in the later stage, the temperature in the baking cavity 110 rises more quickly. For example, the time required to heat to 250° C. in the preheating stage ranges from 10 to 15 minutes, and when it is heated to 400° C. in the later stage, it merely takes 4-5 minutes. Therefore, the second power being greater than the first power can speed up the heating rate of the baking cavity 110, and thus speeding up the baking of the food.

Referring to FIGS. 2, 3, and 4, in an embodiment of the present disclosure, the oven 1000 further includes a baking pan 300 and a fan 400. The baking pan 300 is installed in the baking cavity 110 and is configured to hold food. The fan 400 is installed on the inner sidewall of the body 100 and is configured to speed up hot air circulation in the baking cavity 110, so as to make the temperature distribution in the oven 1000 more uniform. The heating device 200 includes an upper heating tube 210 and a lower heating tube(s) 220 that are respectively located above and below the baking pan 300. The upper heating tube 210 mainly heats the upper portion of the food, and the lower heating tube(s) 220 mainly heats the lower portion of the food.

Referring to FIG. 8, based on the heating control method for the oven 1000 in the above embodiment, controlling, according to the baking instruction, the heating device 200 to enter a quick heating mode specifically includes the following step.

At Step S801: if the baking instruction is a first mode instruction, the upper heating tube 210 is controlled to heat at a third power, and the lower heating tubes 220 are controlled to heat at a fourth power. For example, the upper heating tube 210 heats continuously at the third power, and the lower heating tube 220 heats continuously at the fourth power. The sum of the third power and the fourth power is the second power.

The first mode instruction is generally used for baking pastries and other foods, such as cakes and pizza. Taking baking pizza as an example, the preheating temperature of baking pizza can be 250° C. When reaching the preheating temperature, the first mode instruction is acquired, that is, the user presses the function button of the first mode. The first mode instruction includes various preset parameters required for baking pizza, such as baking temperature, baking time, control logics of the upper heating tube 210 and the lower heating tubes 220, and the heating power of the upper heating tube 210 and the lower heating tubes 220. Therefore, pizza can be baked with one click, reducing the user's operating steps and improving the user experience.

When the first mode instruction is acquired, the upper heating tube 210 is controlled to heat continuously at the third power, and the lower heating tubes 220 are controlled to heat continuously at the fourth power. At this time, the fan 400 does not work. It may be understood that baked pizza needs to be softly cooked and able to be drawn to maintain the taste of the pizza. If the fan 400 is turned on when baking pizza, it is easy to cause the moisture loss on the surface of the pizza to be accelerated. Therefore, the pizza baked with the fan 400 turned on is dry and has a bad taste. In another embodiment of the present disclosure, the upper heating tube 210 can be intermittently heated at the third power, and the lower heating tubes 220 can be intermittently heated at the fourth power. Referring specifically to the foregoing embodiments, it will not be described in detail here in this embodiment.

In an embodiment of the present disclosure, the baking temperature of the pizza ranges from 350 to 370° C., and the baking time, that is, the first preset duration is in a range of 3 to 8 minutes. It may be understood that, using the heating control method according to an embodiment of the present disclosure, the pizza can be baked within 3-8 minutes. Generally speaking, vegetable pizza takes less time, while meat pizza takes longer. For ordinary ovens on the market, the temperature for baking pizza is maintained at around 200° C., and the required time ranges generally from 15 to 25 minutes. For example, baking a pizza with the same ingredients and size only takes 8 minutes using the heating control method of the present disclosure, while it takes 25 minutes using the heating method in the existing technology. Therefore, by adopting the heating control method according to an embodiment of the present disclosure, the pizza can be baked faster and the user's waiting time can be shortened. Although high temperatures will speed up the loss of moisture, since it only takes 3-8 minutes to bake a pizza, the time is not long, the moisture loss is small, and the baked pizza will not be too dry. Therefore, the user can ensure the taste of pizza on the premise of shortening the waiting time, which improves the user experience.

Referring to FIGS. 2, 3, and 4, in an embodiment of the present disclosure, the oven 1000 further includes a baking pan 300 and a fan 400. The baking pan 300 is installed in the baking cavity 110 and is configured to hold food. The fan 400 is installed on the inner sidewall of the body 100 and is configured to speed up hot air circulation in the baking cavity 110, so as to make the temperature distribution in the oven 1000 more uniform. The heating device 200 includes an upper heating tube 210 and lower heating tubes 220 that are respectively located above and below the baking pan 300. The upper heating tube 210 mainly heats continuously the upper portion of the food, and the lower heating tubes 220 mainly heat continuously the lower portion of the food. Since the baking cavity 110 is in a flat shape, the fan 400 is disposed on the inner side wall of the body 100 to unify the overall structure of the oven 1000.

Referring to FIG. 9, based on the heating control method for the oven 1000 in the above embodiment, controlling, according to the baking instruction, the heating device 200 to enter a quick heating mode specifically includes the following step.

At Step S901: if the baking instruction is a second mode instruction, the upper heating tube 210 is controlled to heat at the second power, and the fan 400 is controlled to work, so as to speed up the air circulation in the baking cavity 110.

The second mode instruction is generally intended for meat foods, such as steak and lamb chops. Taking baking steak as an example, the preheating temperature for baking steak can be 250° C. When reaching the preheating temperature, the second mode instruction is acquired, that is, the user presses the function button of the second mode. The second mode instruction includes various preset parameters required for baking the steak, such as baking temperature, baking time, control logics of the upper heating tube 210 and the lower heating tubes 220, and whether the fan 400 is working. Therefore, the steak can be grilled with one click, reducing the user's operating steps and improving the user ecperience.

When the first mode instruction is acquired, the upper heating tube 210 is controlled to heat the baking cavity 110, the lower heating tubes 220 do not work, and the fan 400 is controlled to work. The fan 400 is disposed on the left or rear side of the baking cavity 110, that is, one side in the length direction of the baking cavity 110, so that it is convenient to blow the heat generated by the upper heating tube 210 and the lower heating tubes 220 from the end close to the fan 400 to the end away from the fan 400, which speeds up hot air circulation in the baking cavity 110 and spreads the hot air throughout most of the baking cavity 110, thereby making the temperature distribution inside the baking cavity 110 more uniform, speeding up the baking speed of meat foods, and further improving the quality of cooking.

It may be understood that when baking a steak, the upper surface of the steak is required to be crispy and the lower surface is just cooked, so that the lower heating tubes 220 do not work, which leads to the lower surface of the steak being raw. The fan 400 can better solve this problem. The fan 400 can make the temperature distribution in the baking cavity 110 more uniform, making up for the insufficient temperature for baking the lower surface of the steak. Moreover, turning on the fan 400 can speed up the loss of food moisture, so that it is easy to make the surface of the steak crispy. The sauce will be added to the steak after it is cooked. It is to be noted that in another embodiment of the present disclosure, since the lower heating tube 220 does not need to work, the oven 100 may not be provided with the lower heating tube 220.

In an embodiment of the present disclosure, the baking temperature for grilling steak ranges from 400 to 410° C., and the baking time, that is, the first preset duration is in a range of 2-6 minutes. It may be understood that, using the heating control method according to an embodiment of the present disclosure, the steak can be cooked within 2-6 minutes. The grilling time is different according to the different doneness required by the user, and certainly, is also related to the thickness of the steak. In ordinary ovens on the market, the temperature for grilling steak is maintained at around 210° C., and the required time is generally in a range of 17-25 minutes. For example, when steaks have the same thickness and size, the time required to grill a steak is 6 minutes using the heating control method according to an embodiment of the present disclosure, while the required time is 25 minutes using the method in the existing technology. Therefore, by adopting the heating control method according to an embodiment of the present disclosure, the steak can be cooked faster and the user's waiting time can be shortened.

When the preheating of the oven 1000 is completed, if the user does not perform further operations, maintaining the heat preservation state is a high power consumption behavior and can easily reduce the service life of the oven 1000. Therefore, after the oven 1000 performs the heat preservation for a period of time and the user does not bake foods, the heating device 200 needs to be controlled to stop heating. Therefore, referring to FIG. 10, in an embodiment of the present disclosure, after controlling the heating device 200 to perform the heat preservation operation at the preheating temperature, the heating control method further includes:

At Step S1001: when the heating device 200 performs heat preservation operation at the preheating temperature for a second preset duration, the heating device 200 is controlled to stop heating.

In an embodiment of the present disclosure, the second preset duration is in a range of 5-20 minutes. It is to be noted that the second preset duration may be a parameter that has been determined after the oven 1000 leaves the factory, or may be a parameter set by the user. An appropriate scheme is specifically selected based on the actual situation, and is no longer specifically limited here in the present disclosure.

An embodiment of the present disclosure also provides an oven 1000. The oven 1000 includes: a memory, a processor, and a computer program stored on the memory and executable on the processor. The processor and memory may be connected via a bus or other means.

As a non-transitory computer-readable storage medium, the memory can be configured to store non-transitory software programs and non-transitory computer-executable programs. In addition, the memory may include high-speed random access memories and may also include non-transitory memories, such as at least one magnetic disk storage device, flash memory device, or other non-transitory solid-state storage device. In some implementations, the memory optionally includes memories located remotely from the processor, and these remote memories may be connected to the processor via networks. Examples of the above networks include but are not limited to the Internet, intranets, local area networks, mobile communication networks and combinations thereof.

The non-transitory software programs and instructions required to implement the control method for an oven in the above embodiments are stored in the memory. When executed by the processor, the control method for an oven in the above embodiments is executed, for example, the above-described method steps S501 to S508 in FIG. 5, method step S509 in FIG. 6, method step S510 in FIG. 7, method step S801 in FIG. 8, method step S901 in FIG. 9, and method step S1001 in FIG. 10 are executed.

The device embodiments described above are merely illustrative, and the units described as separate components may be or may not be physically separate, that is, they may be located in one place, or may be distributed over a plurality of network units. Some or all of the modules can be selected according to actual needs to achieve the purpose of the schemes of this embodiment.

The embodiments of the present disclosure have been described in detail above in conjunction with the accompanying drawings. However, the present disclosure is not limited to the above embodiments. Within the scope of knowledge possessed by a person having ordinary skill in the art, various changes can also be made without departing from the purpose of the present disclosure.

1. A heating control method for an oven comprising a body, a heating device, and a baking cavity defined in the body, a size of the baking cavity in a vertical direction being less than that of any side of the baking cavity in a horizontal direction, and the heating device being disposed in the baking cavity and arranged in the horizontal direction;
the control method comprising:
acquiring a preheating instruction;
controlling, according to the preheating instruction, the heating device to heat the baking cavity at a first power;
acquiring a temperature in the baking cavity;
in response to real temperature in the baking cavity being greater than or equal to a preset preheating temperature, controlling the heating device to perform a heat preservation operation at the preset preheating temperature;
acquiring a baking instruction;
controlling, according to the baking instruction, the heating device to enter a quick heating mode, wherein controlling the heating device to enter the quick heating mode comprises controlling the heating device to heat the baking cavity at a second power;
in response to the real temperature in the baking cavity being greater than or equal to a preset baking temperature, controlling the heating device to perform the heat preservation operation at the preset baking temperature, wherein the preset baking temperature is greater than or equal to the preset preheating temperature; and
after the heating device is in the quick heating mode for a first-preset duration, controlling the heating device to stop heating or to perform the heat preservation operation at a preset temperature, wherein the preset temperature is less than or equal the preset baking temperature.

2. The heating control method for the oven according to claim 1, wherein the preset preheating temperature ranges from 200° C. to 400°C.

3. The heating control method for the oven according to claim 1, wherein the preset baking temperature ranges from 300 C. to 500°C.

4. The heating control method for the oven according to claim 1, wherein the preset duration is in a range of 1 minutes to 10 minutes as an optimal duration for a single baking of food.

5. (canceled)

6. The heating control method for the oven according to claim 1, wherein the oven further comprises an accessory installed in the baking cavity, and the heating device comprises an upper heating tube and a lower heating tube that are respectively located above and below the accessory; and controlling, according to the baking instruction, the heating device to enter the quick heating mode comprises:
in response to the baking instruction being a first mode instruction, controlling the upper heating tube to heat at a third power, and controlling the lower heating tube to heat at a fourth power.

7. The heating control method for the oven according to claim 1, wherein the oven further comprises an accessory installed in the baking cavity, and the heating device comprises an upper heating tube located above the accessory; and
controlling, according to the baking instruction, the heating device to enter the quick heating mode comprises:
in response to the baking instruction being a second mode instruction, controlling the upper heating tube to heat at the second power.

8. The heating control method for the oven according to claim 1, wherein the oven further comprises a selectable fan installed on an inner sidewall of the body; and
controlling the heating device to enter the quick heating mode further comprises:
controlling the fan to work, so as to speed up air circulation in the baking cavity.

9. (canceled)

10. An oven, comprising:
a body
a heating device,
a baking cavity defined in the body, a size of the baking cavity in a vertical direction being less than that of any side of the baking cavity in a horizontal direction, and the heating device being disposed in the baking cavity and arranged in the horizontal direction; and
a processor configured to execute a preset setting to implement a heating control method for oven comprising:
acquiring a preheating instruction;
controlling, according to the preheating instruction, the heating device to heat the baking cavity at a first power;
acquiring a temperature in the baking cavity:
in response to real temperature in the baking cavity being greater than or equal to a preset preheating temperature, controlling the heating device to perform a heat preservation operation at the preset preheating temperature;
acquiring a baking instruction;
controlling, according to the baking instruction, the heating device to enter a quick heating mode, wherein controlling the heating device to enter the quick heating mode comprises controlling the heating device to heat the baking cavity at a second power;
in response to the real temperature in the baking cavity being greater than or equal to a preset baking temperature, controlling the heating device to perform the heat preservation operation at the preset baking temperature, wherein the preset baking temperature is greater than or equal to the preset preheating temperature; and
after the heating device is in the quick heating mode for a preset duration, controlling the heating device to stop heating or to perform the heat preservation operation at a preset temperature, wherein the preset temperature is less than or equal to the preset baking temperature.

11. The heating control method for the oven according to claim 2, wherein the preset baking temperature ranges from 300° C. to 500°C.

12. The oven according to claim 10, wherein the preset preheating temperature ranges from 200° C. to 400°C.

13. The oven according to claim 10, wherein the preset baking temperature ranges from 300° C. to 500°C.

14. The oven according to claim 12, wherein the preset baking temperature ranges from 300° C. to 500°C.

15. The oven according to claim 10, wherein the preset duration is in a range of 1 minute to 10 minutes as an optimal duration for a single baking of food.

16. The oven according to claim 10, wherein the oven further comprises an accessory installed in the baking cavity, and the heating device comprises an upper heating tube and a lower heating tube that are respectively located above and below the accessory; and
controlling, according to the baking instruction, the heating device to enter the quick heating mode comprises:
in response to the baking instruction being a first mode instruction, controlling the upper heating tube to heat at a third power, and controlling the lower heating tube to heat at a fourth power.

17. The oven according to claim 10, wherein the oven further comprises an accessory installed in the baking cavity, and the heating device comprises an upper heating tube located above the accessory; and
controlling, according to the baking instruction, the heating device to enter the quick heating mode comprises:
in response to the baking instruction being a second mode instruction, controlling the upper heating tube to heat at the second power.

18. The oven according to claim 10, wherein the oven further comprises a selectable fan installed on an inner sidewall of the body; and
controlling the heating device to enter the quick heating mode further comprises:
controlling the fan to work, so as to speed up air circulation in the baking cavity.
